(19) United States
(12) Patent Application Publication
(10) Pub. No.: US 2014/0028847 A1
(43) Pub. Date: Jan. 30, 2014

(54) IMAGE CAPTURE SYSTEM AND IMAGE CAPTURE METHOD

(71) Applicant: Yu-Min Wang, Hsinchu County (TW)

(72) Inventor: Yu-Min Wang, Hsinchu County (TW)

(21) Appl. No.: 13/628,059

(22) Filed: Sep. 27, 2012

(30) Foreign Application Priority Data
Jul. 30, 2012 (TW) 101127477

(51) Int. Cl. H04N 7/18

(52) U.S. Cl. 348/148; 348/E07.085

(57) ABSTRACT

An image capture system adapted for a movable vehicle is provided. The image capture system includes a camera apparatus, a capture apparatus and a positioning analyzer. The positioning analyzer is adapted for analyzing a traveling direction of the movable vehicle. The capture apparatus is coupled to the camera apparatus and the positioning analyzer to receive image frames taken by the camera apparatus, and captures the image frames according to a cropping window. Further, the capture apparatus decides whether correspondingly adjusts the cropping window for capturing the image frames according to the traveling direction. In addition, an image capture method adapted for an image capture system installed on a movable vehicle is provided.

### CROSS-REFERENCE TO RELATED APPLICATION

This application claims the priority benefit of Taiwan application serial no. 101127477, filed on Jul. 30, 2012. The entirety of the above-mentioned patent application is hereby incorporated by reference herein and made a part of this specification.

### BACKGROUND

1. Field of the Invention

The invention is directed to an image capture system and an image capture method and more particularly, to image capture system and an image capture method adapted for a movable vehicle.

2. Description of Related Art

Along with the development of electronic and optical technologies in recent years, camera apparatuses have been gradually developed toward miniaturization and lightweight. For instance, most mobile devices and compact-sized cameras adopt image sensors such as charge coupling devices (CCD) or complementary metal-oxide semiconductors (CMOS) for sensing images to achieve the effects of reducing device sizes. In the meantime, with the improvement of image processing technology, such type of camera apparatus can sufficiently store a large amount of image data only by using a built-in storage element, such as a memory, or a general-type built-in hard disk, without connecting external storage devices.

As a result of the forgoing advantages, the camera apparatus may also be applied to some usage that has never been thought of in the past, in which a driving recorder is one of the examples. The camera apparatus integrated in the driving recorder is required to record driving image frames continuously to provide a driver with a complete driving record and protect the driver's interests once a car accident occurs. FIG. 1 is a schematic operation diagram of a general type driving recorder. Generally, a driving recorder 1100 installed in a vehicle 1000 has a camera with unchanged view angle and direction while driving and a range R for capturing image frames is also fixed. When the vehicle takes a turn, the driving recorder remains recording the image frames captured within the fixed range R in front of the camera since the viewing angle of the camera is still unchanged. Thus, the captured image frames are in a different direction from what the driver sees toward, and no accurate image frames can be obtained. For example, a moving objective 1200 shown in FIG. 1 can not be recorded or captured.

### SUMMARY

The invention is directed to an image capture system adapted for a movable vehicle. The image capture system analyzes a traveling direction of a vehicle and adjusts a range for capturing image frames according to the traveling direction.

The invention is directed to an image capture system adapted for a movable vehicle. The image capture system includes a camera apparatus, a capture apparatus and a positioning analyzer. The positioning analyzer determines a traveling direction of the vehicle. The capture apparatus is coupled to the camera apparatus and the positioning analyzer. The capture apparatus receives a plurality of image frames taken by the camera apparatus and captures the image frames according to a cropping window. The capture apparatus further decides whether to correspondingly adjust the cropping window according to the traveling direction determined by the positioning analyzer.

In an embodiment of the invention, when the traveling direction of the vehicle is changed from a first direction to a second direction, the capture apparatus moves the cropping window on the image frames along a specific direction corresponding to the second direction.

In an embodiment of the invention, the camera apparatus has a camera window and takes the image frames according to the camera window. The camera window is larger than or equal to the cropping window.

In an embodiment of the invention, the positioning analyzer is further coupled to the camera apparatus and outputs an adjustment instruction to the camera apparatus. The camera apparatus adjusts the camera window according to the adjustment instruction and takes the image frames according to the camera window.

In an embodiment of the invention, the positioning analyzer receives the image frames captured by the capture apparatus and calculates a plurality of motion vectors between a current image frame and a previous image frame among the captured image frames so as to determine the traveling direction of the vehicle according to the plurality of motion vectors.

On the other hand, the invention is directed to an image capture method adapted for an image capture system installed on a movable vehicle. The image capture method includes taking a plurality of image frames, capturing the image frames according to a cropping window, determining a traveling direction of the vehicle and adjusting the cropping window according to the traveling direction of the vehicle.

In an embodiment of the invention, the step of adjusting the cropping window further includes moving the cropping window on the image frames along a specific direction corresponding to the second direction when the traveling direction of the vehicle is changed from a first direction to a second direction.

In an embodiment of the invention, the step of taking the image frames further includes taking the image frames according a camera window, wherein the camera window is larger than or equal to the cropping window.

In an embodiment of the invention, the step of taking the image frames further includes adjusting the camera window and taking the image frames according to the camera window.

In an embodiment of the invention, the step of determining the traveling direction of the vehicle includes calculating a plurality of motion vectors between a current image frame and a previous image frame among the captured image frames so as to determine the traveling direction of the vehicle according to the motion vectors.

In an embodiment of the invention, the step of calculating the motion vectors further includes getting M first blocks from the current image frame, searching for a plurality of second blocks corresponding to the first blocks on the previous image frame and calculating the motion vector between each of first blocks from the current image frame and the corresponding block among the plurality of second blocks on the previous image frame. M is a positive integer.

In an embodiment of the invention, the step of determining the traveling direction further includes determining the traveling direction of the vehicle according to a portion of the plurality of motion vectors.

In an embodiment of the invention, the image capture method further includes compressing the captured image frames according to an image compression standard and storing the compressed image frames.

The invention is further directed to an image capture system adapted for a movable vehicle. The image capture system includes a camera apparatus, a capture apparatus and a positioning analyzer. The camera apparatus adjusts a camera window according to an adjustment instruction and takes a plurality of image frames according to the camera window. The capture apparatus is coupled to the camera apparatus to receive the image frames taken by the camera apparatus. The positioning analyzer is coupled to the capture apparatus and the camera apparatus, determines a traveling direction of the vehicle and outputs the adjustment instruction to the camera apparatus according to the traveling direction.

The invention is yet further directed to an image capture system, adapted for a movable vehicle. The image capture system includes a camera apparatus, a positioning analyzer and a capture apparatus. The camera apparatus adjusts a camera window according to an adjustment instruction and takes a plurality of image frames according to the camera window. The positioning analyzer determines a traveling direction of the vehicle. The capture apparatus is coupled to the camera apparatus and the positioning analyzer to receive the image frames captured by the camera apparatus and outputs the adjustment instruction to the camera apparatus according to the traveling direction.

In an embodiment of the invention, when the traveling direction of the vehicle is changed, the camera apparatus adjusts the camera window according to the adjustment instruction.

In an embodiment of the invention, the positioning analyzer calculates a plurality of motion vectors between a current image frame and a previous image frame among the image frames so as to determine the traveling direction of the vehicle according to the motion vectors.

In an embodiment of the invention, when the image capture system calculates the motion vectors between the current image frame and the previous image frame, M first blocks are gotten from the current image frame, multiple second blocks corresponding to the first blocks are searched on the previous image frame, and the motion vector between each of first blocks and the corresponding block among the plurality of second blocks is calculated. M is a positive integer.

In an embodiment of the invention, the positioning analyzer determines the traveling direction of the vehicle according to a portion of the plurality of motion vectors.

In an embodiment of the invention, the positioning analyzer includes a first buffer and a second buffer. The first buffer and the second buffer are configured to store the current image frame and the previous image frame, respectively.

In an embodiment of the invention, the image capture system further includes an image compression unit. The image compression unit is coupled to the capture apparatus and compresses the image frames captured by the capture apparatus according to an image compression standard.

In an embodiment of the invention, the image capture system further includes a memory unit. The memory unit is coupled to the image compression unit and stores the image frames compressed by the image compression unit.

In an embodiment of the invention, the positioning analyzer includes a gyroscope, an electronic compass (e-compass) or a global position system (GPS) to determine the traveling direction of the vehicle.

To sum up, in the invention, the traveling direction of the vehicle is determined by the positioning analyzer, and the cropping window of the capture apparatus of and the camera window of the camera apparatus are dynamically adjusted, so that when the traveling direction of the image capture system is changed, the images frames having the same view angle as a user's view angle can still be taken and captured. Additionally, the image capture system of the invention does not require additional devices installed for moving the image capture system, so that production cost and apparatus sizes can be reduced.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic operation diagram of a general type driving recorder.

FIG. 2 is a schematic diagram illustrating an image capture system according to an embodiment of the invention.

FIG. 3 is a schematic functional block diagram of the image capture system depicted in FIG. 2 according to an embodiment of the invention.

FIG. 4A and FIG. 4B illustrate movement of a vehicle according to an embodiment of the invention.

FIG. 5A˜FIG. 5C are schematic operation diagrams of the cropping window.

FIG. 6A˜FIG. 6C are schematic operation diagrams of operating the camera window.

FIG. 7 is schematic diagram of determining motion vectors according to an embodiment of the invention.

FIG. 8 is a schematic functional block diagram of the image capture system depicted in FIG. 2 according to another embodiment of the invention.

FIG. 9 is a schematic functional block diagram of the image capture system depicted in FIG. 2 according to still another embodiment of the invention.

FIG. 10 is a flowchart illustrating an image capture method according to an embodiment of the invention.

FIG. 11 is a flowchart illustrating the detailed method of determining the vehicle traveling direction in step S1030 of FIG. 10.

### DESCRIPTION OF EMBODIMENTS

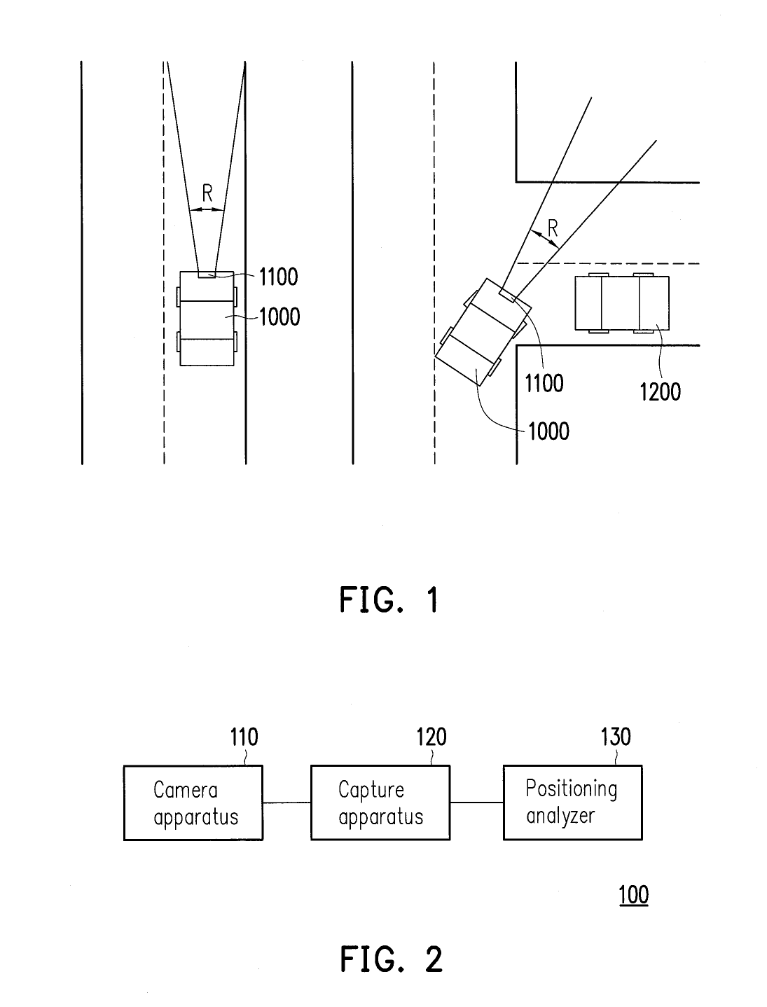

FIG. 2 is a schematic diagram illustrating an image capture system according to an embodiment of the invention. Referring to FIG. 2, an image capture system 100 is adapted for/installed on a movable vehicle (e.g. an automobile, a motorcycle, a bicycle, or a user's helmet). The image capture system 100 includes a camera apparatus 110, a capture apparatus 120 and a positioning analyzer 130. The positioning analyzer 130 determines a traveling direction of the vehicle (or the image capture system 100). Any circuit having a function of determining direction may be used to implement the positioning analyzer 130. For example, the positioning analyzer 130 may include a gyroscope, an electronic compass (e-compass) or a global position system (GPS). Or, the positioning analyzer 130 may analyze image frames provided by the camera apparatus 110 or the capture apparatus 120 and then, determine the traveling direction of the vehicle (or the image capture system 100) according to an analyzing result.

The camera apparatus 110 takes a plurality of image frames continuously. The capture apparatus 120 is coupled to the camera apparatus 110 and the positioning analyzer 130. The capture apparatus 120 receives the image frames taken by the camera apparatus 110 and captures the image frames according to a cropping window. The capture apparatus 120 further decides whether to correspondingly adjust the cropping window according to the traveling direction determined by the positioning analyzer 130. The image capture system 100 determines the traveling direction of the vehicle by using the positioning analyzer 130. The positioning analyzer 130 transmits a message including the traveling direction to the capture apparatus 120 and/or the camera apparatus 110 or alternatively, outputs an adjustment instruction to the capture apparatus 120 and/or camera apparatus 110 according to the traveling direction of the vehicle. For example, the positioning analyzer 130 may transmit the message including the traveling direction to the capture apparatus 120, and the capture apparatus 120 then may correspondingly adjust the cropping window according to the message including the traveling direction. In addition, for example, the positioning analyzer 130 may transmit the adjustment instruction to the camera apparatus 110, and the camera apparatus 110 then may correspondingly adjust the camera window according to the message including the traveling direction.

In the present embodiment, the traveling direction of the vehicle is determined by the positioning analyzer 130, while the capture apparatus 120 dynamically adjusts the cropping window an/or the camera window of the camera apparatus 110 according to the traveling direction, such that when the traveling direction is changed, the image capture system 100 still may change a capturing direction in response to the direction change of the vehicle. The operation method of the image capture system 100 in several operation scenarios according to the embodiments will be described hereinafter.

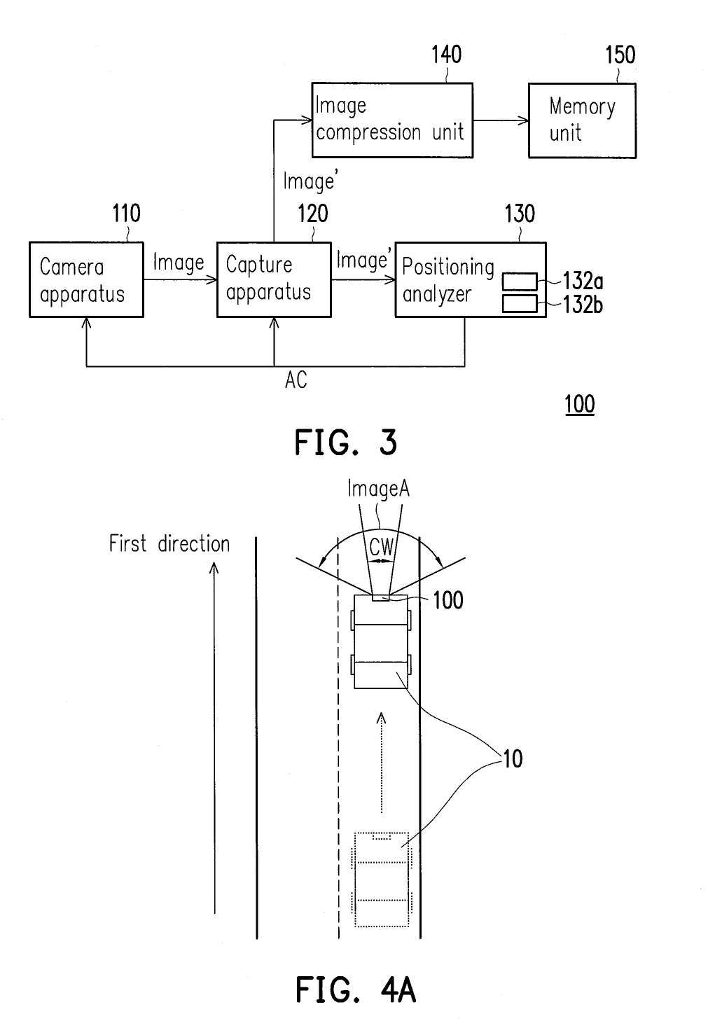

FIG. 3 is a schematic functional block diagram of the image capture system 100 depicted in FIG. 2 according to an embodiment of the invention. The embodiment as illustrated in FIG. 3 may be referred to the related description of FIG. 2. In the embodiment as illustrated in FIG. 3, after the traveling direction of the vehicle is determined by the positioning analyzer 130, the positioning analyzer 130 outputs an adjustment instruction AC to the capture apparatus 120 to adjust the cropping window of the capture apparatus 120. In addition, the camera apparatus 110 has a camera window and takes a plurality of image frames according to the camera window. The positioning analyzer 130 outputs the adjustment instruction AC to the camera apparatus 110 according to the traveling direction of the vehicle so as to adjust the camera window of the camera apparatus 110.

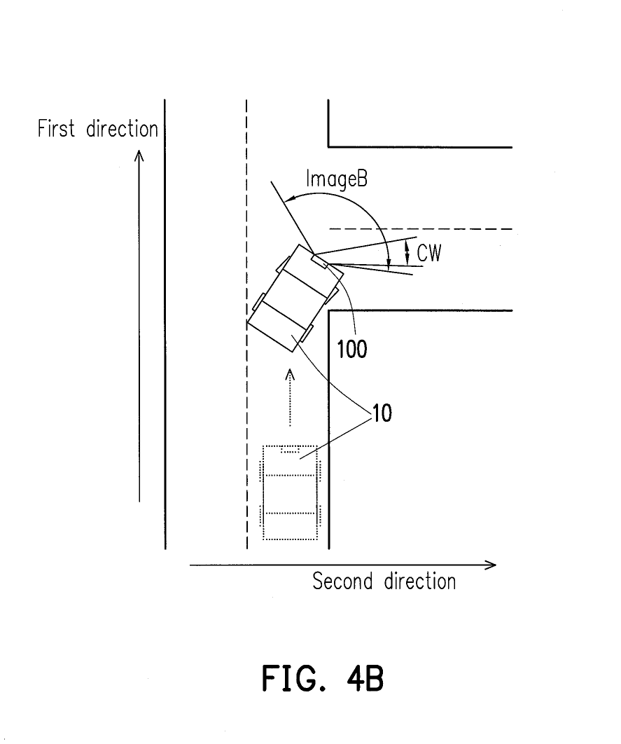

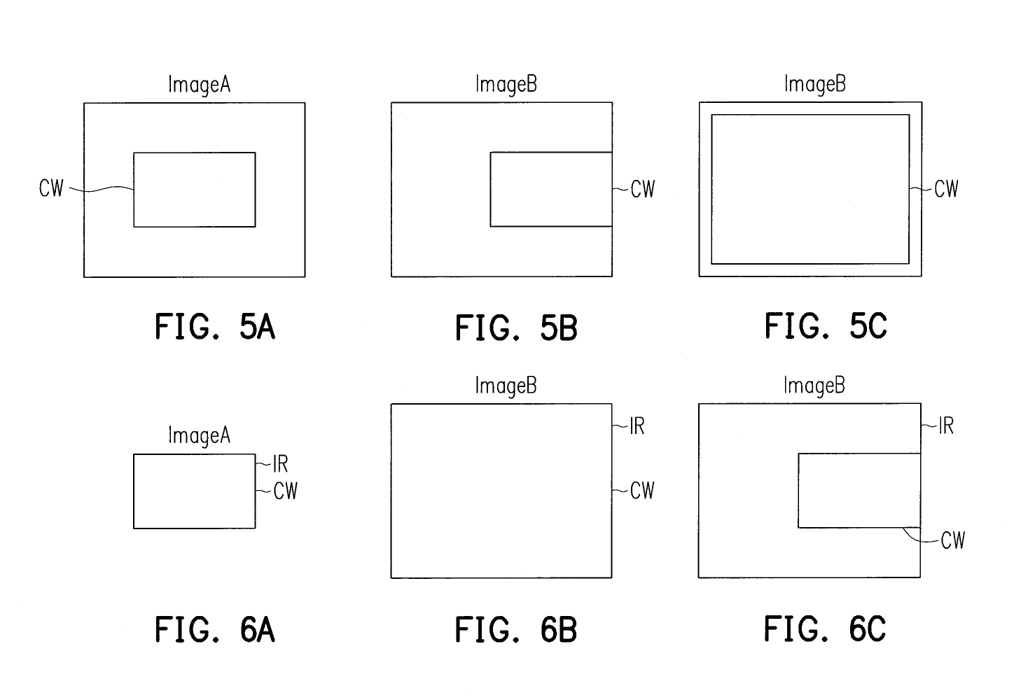

FIG. 4A is a schematic diagram illustrating movement of a vehicle 10 according to the present embodiment. FIG. 5A is a schematic diagram of a cropping window CW of the image capture system 100 operated in the scenario as shown in FIG. 4A. Referring to FIG. 3, FIG. 4A and FIG. 5A, when the vehicle 10 carrying the image capture system 100 moves along a traveling direction (e.g. a first direction shown in FIG. 4A), the image capture system 100 continuously takes and captures a plurality of image frames, such as an image frame ImageA shown in FIG. 5A. After the capture apparatus 120 receives the image frame ImageA, the capture apparatus 120 partially or entirely captures the image frame ImageA according to a position and a size of the cropping window CW. In the present embodiment, the camera window (i.e. the taken image frame ImageA) of the camera apparatus 110 is larger than or equal to the cropping window CW of the capture apparatus 120. Alternatively, when comparing the image frame ImageA taken by the camera apparatus 110 with the image captured by the capture apparatus 120 according to the cropping window CW, the former has the larger image frame.

The captured image frame is inputted to the positioning analyzer 130 for analyzing/determining the traveling direction of the vehicle 10. In the present embodiment, the positioning analyzer 130 may use a motion estimation technique to determine the traveling direction of the vehicle 10, of which the details will be describe below. How the positioning analyzer 130 analyzes/determines the traveling direction is not limited to the motion estimation technique. When the traveling direction of the vehicle 10 remains driving in a straight forward direction (e.g. the first direction shown in FIG. 4A), the capture apparatus 120 configures the cropping window CW in the central portion of the image frame ImageA (as shown in FIG. 5A). The capture apparatus 120 captures the image frame ImageA by using the cropping window CW to save storage space required for storing each image frame and retain the image that is more important. For example, comparing with the sky scene over the image frame ImageA and buildings at the left and the right of the image frame ImageA, the driving way and a vehicle in front of the vehicle 10 depicted in FIG. 4A are more important. Capturing the partial image frame within the cropping window CW from the image frame ImageA by the capture apparatus 120 not only saves the storage space for storing the image frame, but also clearly records an important key image (e.g. the car identification number of the front vehicle).

FIG. 4B is a schematic diagram illustrating the movement of the vehicle 10 according to another embodiment. FIG. 5B is a schematic diagram of the cropping window CW of the image capture system 100 operated in the scenario as shown in FIG. 4B. Referring to FIG. 3, FIG. 4B and FIG. 5B, when the positioning analyzer 130 determines by using the motion estimation technique that the traveling direction of the vehicle 10 is changed from the straight forward direction (for example, the vehicle 10 depicted in FIG. 4B takes a turn from the first direction to a second direction), the positioning analyzer 130 outputs the adjustment instruction AC to the capture apparatus 120. At this time, the capture apparatus 120 moves the cropping window CW on an image frame to be processed (e.g. an image frame ImageB depicted in FIG. 4B) along a specific direction corresponding to the second direction according to the adjustment instruction AC. For example, when the vehicle 10 depicted in FIG. 4B takes a turn, the cropping window CW depicted in FIG. 5B moves toward one side of the image frame ImageB. Comparing with a range of the image frame ImageA captured according to the cropping window CW depicted in FIG. 4A, a range of the image frame ImageB captured by the capture apparatus 120 depicted in FIG. 5B trends toward one side of the image frame ImageB rather than the center. Through the aforementioned operation, the image capture system 100 may dynamically adjusts the range for capturing image frames while the traveling direction is changed. That is to say, the direction for capturing image frames by the image capture system 100 may be automatically changed corresponding to the traveling direction of the vehicle 10.

Following the above example, in FIG. 4B, when the vehicle 10 takes a turn to the right, the cropping window CW moves on the image frame ImageB along a direction corresponding to the right of the vehicle 10 according to the adjustment instruction AC. In FIG. 4B, if the taken image frame ImageB is in the same direction as the corresponding outside scene, the cropping window CW also moves toward the right of the image frame ImageB. Otherwise, if the taken image frame ImageB is reversed or contrary to the outside scene, the cropping window moves toward the left of the image frame ImageB to obtain a desired image frame. Whether the taken image frame is in the same direction as the outside scene is decided by a design of an optical engine (a lens set) of the camera apparatus 110. When the vehicle 10 takes a turn to the right as shown in FIG. 4B, objectives (such as pedestrians or the preceding vehicle) in the right front of the vehicle 10 may influence the movement of the vehicle, and thus, the image capture system 100 has to clearly record the scene in the right front of the vehicle 10. By moving the cropping window CW to a place corresponding to the taken image frame ImageB, the capture apparatus 120 only needs to capture a portion of the image frame ImageB within the cropping window CW (for example, the scene in the right front of the vehicle 10) so as to save the storage space for storing the image frame while clearly recording the important key scene/picture.

In other embodiments, the cropping window CW is not limited to being adjusted on the image taken by the camera apparatus 110. For instance, FIG. 5C is a schematic diagram of the cropping window CW of the image capture system 100 operated in the scenario as shown in FIG. 4B according to another embodiment. Referring to FIG. 4B and FIG. 5C, when the traveling direction of the vehicle 10 is changed from the first direction to the second direction (e.g. turning to the right), the capture apparatus 120 enlarges the cropping window CW according to the adjustment instruction AC so as to capture a larger range of the image frame on the image frame ImageB. By enlarging the cropping window CW, the image capture system 100 may obtain an image in a larger view angle (comparing with the image frame captured in FIG. 5C) as desired while the traveling direction is changed. Thus, when the vehicle 10 turns to the right as shown in FIG. 4B, the image capture system 100 at this time may clearly record the scene of the objectives (such as the pedestrians or the preceding vehicle) in the right front of the vehicle 10.

However, how to adjust the range for capturing image frames is not limited to the above. In the embodiment as illustrated in FIG. 3, the camera apparatus 110 has an adjustable camera window and may take a plurality of image frames according to the camera window. The taken images frames are then captured by the capture apparatus 120. FIG. 6A is a schematic diagram illustrating a camera window IR operated in the scenario as shown in FIG. 4A. FIG. 6B and FIG. 6C are schematic diagrams illustrating the camera window IR operated in the scenario as shown in FIG. 4B. Referring to FIG. 3, FIG. 4A˜FIG. 4B and FIG. 6A˜FIG. 6C, the positioning analyzer 130 is coupled to the camera apparatus 110 and also outputs the adjustment instruction AC to the camera apparatus 110. The camera apparatus 110 adjusts the camera window IR according to the adjustment instruction AC and takes a plurality of image frames according to the camera window IR, for example, the image frame ImageA or the image frame ImageB. It should be noted that the cropping window CW in the capture apparatus 120 may have the same size as the camera window IR in the camera apparatus 110 (as shown in FIG. 6A and FIG. 6B) or alternatively, may be adjusted into different sizes or positions according to the adjustment instruction (as shown in FIG. 6C).

In FIG. 4A, when the traveling direction of the vehicle 10 is maintained in the straight forward direction (e.g. the first direction shown in FIG. 4A), the camera apparatus 110 and the capture apparatus 120 adjust the camera window IR (i.e. the range of ImageA as shown in FIG. 4A) and the cropping window CW according to the adjustment instruction AC, respectively and the cropping window CW has the same size and position as the camera window IR. Referring to FIG. 4B and FIG. 6B, when the traveling direction of the vehicle 10 is changed from the straight forward direction to the right (changed from the first direction to the second direction as shown in FIG. 4B), the positioning analyzer 130 outputs the adjustment instruction AC to the capture apparatus 120 and the camera apparatus 110. The camera apparatus 110 and the capture apparatus 120 respectively adjusts the camera window IR (the range of the image frame ImageB shown in FIG. 4B) and the cropping window CW. For example, as shown in FIG. 6B, both the camera window IR and the cropping window CW are enlarged so that the image capture system 100 may capture the image frame in a wider viewing angle and accurately record the image frame as desired (for example, the entire image frame ImageB in the camera window of the vehicle 10 as shown in FIG. 4B).

However, how to adjust the camera window IR and the cropping window CW is not limited to the above. In another embodiment, referring to FIG. 6C, the size of the camera window IR is different from the cropping window CW. Referring to FIG. 4B with FIG. 6C, when the traveling direction of the vehicle 10 is changed from the straight forward direction to the right, the positioning analyzer 130 outputs the adjustment instruction AC to the capture apparatus 120 and the camera apparatus 110. The camera apparatus 110 enlarges the camera window IR to take the image frame ImageB according to the adjustment instruction AC, while the capture apparatus 120 moves the cropping window CW on the image frame ImageB according to the adjustment instruction AC. In this example, the camera window IR is larger than the cropping window CW so that the image capture system 100 may take the image frame in a wider view angle (comparing with the camera window IR shown in FIG. 6A, for example) and capture the image frame as desired (for example, the image frame in the right front of the vehicle 10 as shown in FIG. 4B).

It should be noted that the camera window IR is larger than or equal to the cropping window CW. When the vehicle moves along the first direction, the camera window IR and the cropping window CW may be operated as shown in FIG. 6A to capture the image frame ImageA. When the vehicle takes a turn from the first direction to the second direction, both the camera window IR and the cropping window CW may be enlarged as shown in FIG. 6B or alternatively, as shown in FIG. 6C, the camera window IR is enlarged and the cropping window CW moves on the image frame ImageB along a specific direction corresponding to the second direction depicted in FIG. 4B to capture the image frame ImageB.

Referring to FIG. 3 again, the image capture system 100 further includes an image compression unit 140 and a memory unit 150. The image compression unit 140 is coupled to the capture apparatus 120 and compresses the image frames captured by the capture apparatus 120 according to a specific image compression standard. The image compression standard is, for example, the H.264 standard, the MPEG-4 standard and so forth. The memory unit 150 is coupled to the image compression unit 140 and stores the image frames compressed by the image compression unit 140. For example, the memory unit 150 is a flash memory or a hard disk.

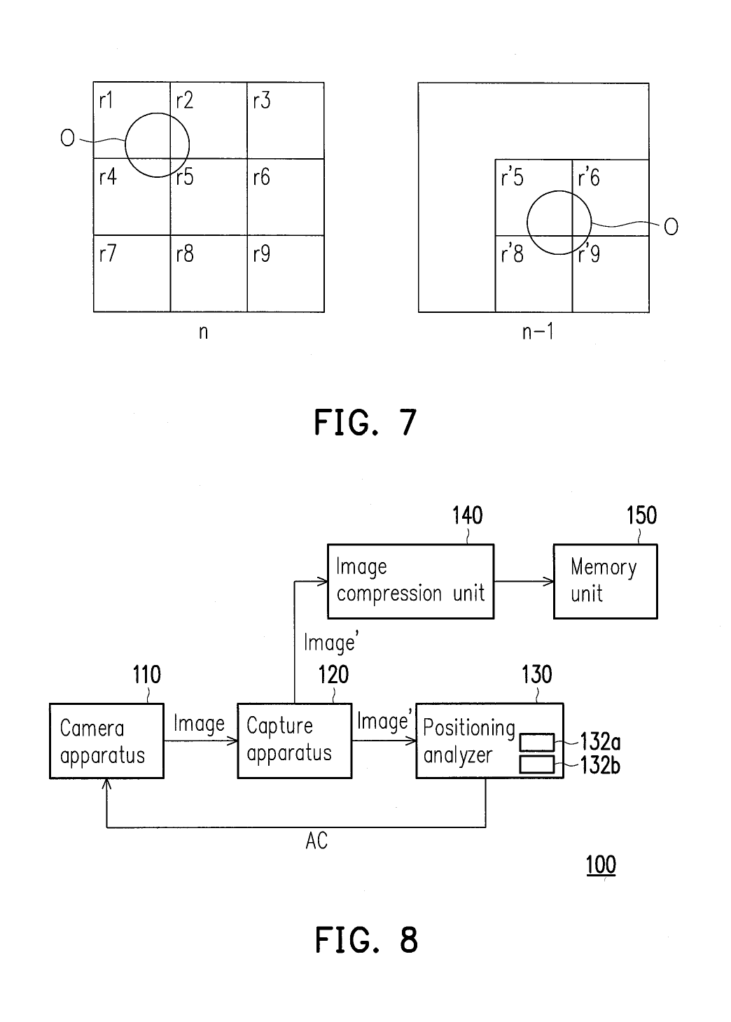

The positioning analyzer 130 in the image capture system 100 may analyze whether the traveling direction of the vehicle 10 is changed by various methods. One of the methods is the motion estimation technique. The motion estimation technique uses the image frames transmitted from the capture apparatus 120 and analyzes/calculates motion vectors between these image frames to determine the traveling direction of the vehicle 10. FIG. 7 is schematic diagram of determining motion vectors according to an embodiment of the invention. Referring to FIG. 3 and FIG. 7, the positioning analyzer 130 calculates two captured image frames Image′, which are a current image frame n and a previous image frame n−1, respectively. The current image frame n and the previous image frame n−1 are two continuous image frames, and the previous image frame n−1 is taken and captured prior to the current image frame n. In order to store the current image frame n and the previous image frame n−1, the positioning analyzer 130 further includes a first buffer 132a and a second buffer 132b to temporarily store the current image frame n and the previous image frame n−1.

In the present embodiment, while the positioning analyzer 130 calculates the motion vectors between the current image frame n and the previous image frame n−1, M (M is a positive integer) first blocks are gotten from the current image frame n. For example, referring to FIG. 7, the positioning analyzer 130 divides the current image frame n to nine first blocks r1˜r9 (herein, M=9). Then, on the previous image frame n−1, a plurality of second blocks corresponding to the first blocks r1˜r9 are searched. Afterward, the positioning analyzer 130 calculates the motion vector between each of the first blocks and its corresponding block among the second blocks and determines the traveling direction of the vehicle according to the motion vectors.

Given that in FIG. 7, each of the current image frame n and the previous image frame n−1 has a same characteristic objective O. First, among the first blocks r1˜r9 gotten from the current image frame n by the positioning analyzer 130, the first blocks r1, r2, r4 and r5 have a portion of the characteristic objective O. Then, the positioning analyzer 130 searches on the previous image frame n−1 for the second blocks corresponding to the first blocks r1˜r9. In FIG. 7, it is inferred from the characteristic objectives O that blocks r′5, r′6, r′8 and r′9 of the previous image frame n−1 are the second blocks corresponding to the first blocks r1, r2, r4 and r5. Lastly, the positioning analyzer 130 calculates the motion vector between each of the first blocks and the corresponding block among the second blocks and then, obtains the traveling direction of the vehicle 10 by summing up and averaging all the motion vectors.

In another embodiment, the positioning analyzer 130 sets different weighted values according to positions of the first blocks in the current image frame and obtain the traveling direction of the vehicle 10 by calculating a weighted average of these motion vectors. For example, the positioning analyzer 130 may multiplies a greater weighted value for the motion vector in the central area of the current image frame and a smaller weighted value for the motion vectors in the other area.

In other embodiments, the positioning analyzer 130 may determine the traveling direction of the vehicle 10 only according to a portion of the motion vectors. For example, if the vehicle 10 is an automobile driving on the road, and objectives that may be taken by the image capture system 100 includes trees and buildings on the road sides, other moving vehicles, the sky and mountain views in distant. When the automobile equipped with the image capture system 100 moves, displacement occurs in image frames taken for the trees and the buildings on the road sides, which may be used to indicate the traveling direction of the automobile. Thus, the area on the left and the right sides of the taken image frames are adapted to determine the traveling direction of the vehicle 10. Accordingly, the positioning analyzer 130 may determine the traveling direction of the vehicle 10 only according to the motion vectors in the area on the left and the right sides of the captured image frames.

Further, for example, the mountain views, clouds and the sky in the distant front of the vehicle 10 have less change in continuously taken image frames. Thus, once these characteristic objectives with less change together and move toward a same direction, it represents that the traveling direction of the vehicle 10 is changed. For example, when the characteristic objectives such as the mountain views, the clouds or the sky in an upper area of the continuously taken image frames together move toward the left, it represents that the vehicle 10 takes a turn to the right. Thus, the positioning analyzer 130 may determine the traveling direction of the vehicle 10 only according to the motion vectors in the upper area of the captured image frames.

The positioning analyzer 130 may also be capable of excluding inapplicable motion vectors and determine the traveling direction of the vehicle 10 by using only a portion of the motion vectors. For example, after collecting all the motion vectors on the current image frame, the positioning analyzer 130 may filter the motion vectors based on a threshold range. The motion vectors having a standard deviation falling within the threshold range is retained and used to determine the traveling direction of the vehicle 10. Otherwise, the motion vectors having the standard deviation falling out of the threshold range is excluded. Or, the motion vectors having the standard deviation falling within the threshold range is given a weighted value for determining the traveling direction of the vehicle 10.

In addition, when setting the positioning analyzer 130, according to the usage situation of the image capture system 100, the motion vectors obtained on a specific position on the captured image frame may be given priority to be weighted. Taking the automobile driving on the road for example, since typically, the upper area of the taken image frames is the sky and the lower area of the taken image frames is the road surface when the image capture system 100 is used on the automobile, the motion vectors corresponding to these areas may be excluded in advance. On the other hand, since more unmovable characteristic objectives such as sidewalks, street trees, buildings or street lights are located at two sides of the taken images have, the motion vectors corresponding to theses parts may be retained or weighted. The method for excluding the motion vectors as above is merely illustrated for example, and the image capture system 100 of the invention is not limited to the above implementation.

After inapplicable motion vectors are excluded, the positioning analyzer 130 collects and averages (or weighted averages) all the motion vectors on the current image frame to decide whether the traveling direction of the vehicle 10 is changed and outputs the adjustment instruction AC to adjust the cropping window CW and the camera window IR, simultaneously or respectively. However, how the positioning analyzer 130 determines the traveling direction of the vehicle 10 is not limited thereto.

The image capture system 100 illustrated in FIG. 3 is merely one of the embodiments, and the invention is not limited thereto. For instance, FIG. 8 is a schematic functional block diagram of the image capture system 100 depicted in FIG. 2 according to another embodiment of the invention. The embodiment illustrated in FIG. 8 may be referred to the description in connection with FIG. 2 and FIG. 3. Referring to FIG. 8, the image capture system 100 adapted for a movable vehicle includes the camera apparatus 110, the capture apparatus 120 and the positioning analyzer 130. Differing from the embodiment of FIG. 3, in the image capture system 100 illustrated in FIG. 8, the cropping window is not adjusted when the capture apparatus 120 captures the image frames. The capture apparatus 120 partially or entirely captures a plurality of image frames Image taken by the camera apparatus 110 and transmits the captured image frames Image′ to the positioning analyzer 130 and the image compression unit 140. The camera apparatus 110 adjusts the camera window according to the adjustment instruction AC and takes the image frames according to the camera window. The positioning analyzer 130 is coupled the capture apparatus 120 and the camera apparatus 110. The positioning analyzer 130 receives and analyzes the captured image frames Image′ to determine the traveling direction of the vehicle and then, outputs the adjustment instruction AC to the camera apparatus 110 according to the traveling direction of the vehicle.

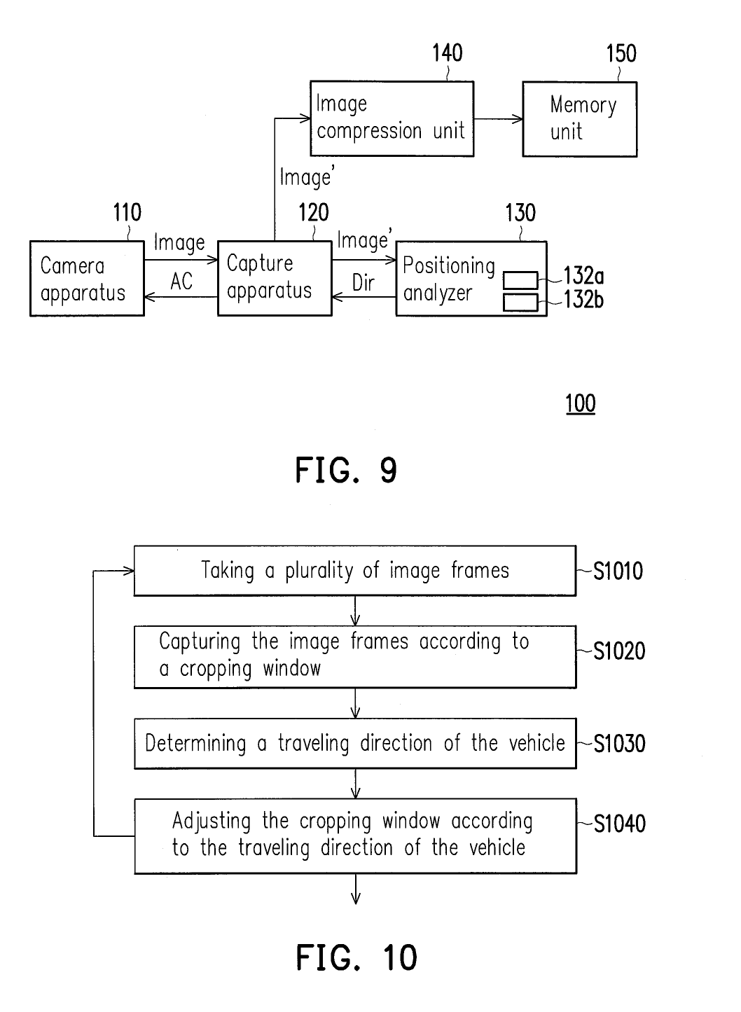

FIG. 9 is a schematic functional block diagram of the image capture system 100 depicted in FIG. 2 according to still another embodiment of the invention. The embodiment illustrated in FIG. 9 may be referred to the description in connection with FIG. 2 and FIG. 3. Referring to FIG. 9, the image capture system 100 adapted for a movable vehicle includes the camera apparatus 110, the capture apparatus 120 and the positioning analyzer 130. In the image capture system 100, the camera apparatus 110 adjusts the camera window according to the adjustment instruction AC and takes a plurality of image frames Image according to the camera window. The capture apparatus 120 is coupled to the camera apparatus 110 and the positioning analyzer 130 to receive and capture the image frames Image taken by the camera apparatus 110 and transmit the captured image frames Image′ to the positioning analyzer 130. After analyzing the captured image frames Image′ to determine the traveling direction of the vehicle, the positioning analyzer 130 transmits a message Dir including the traveling direction to the capture apparatus 120. The capture apparatus 120 outputs the adjustment instruction AC to the camera apparatus 110 according to the message Dir including the traveling direction provided by the positioning analyzer 130.

In the image capture system 100 illustrated in FIG. 8 and in FIG. 9, only the parts different from the image capture system 100 illustrated in FIG. 3 are described, and the other parts are referred to the embodiment illustrated in FIG. 3, which will not be repeated hereinafter.

An image capture method adapted for an image capture system installed on a movable vehicle will be described hereinafter. FIG. 10 is a flowchart illustrating the image capture method. Referring to FIG. 10, in step S1010, a plurality of image frames is taken. In step S1020, the image frames are captured according to a cropping window. Then, in step S1030, a traveling direction of the vehicle is determined. In the present embodiment, the traveling direction of the vehicle is determined by using the captured image frames. Lastly, in step S1040, the cropping window is adjusted according to the traveling direction of the vehicle. Further, the cropping window is moved or zoomed on the image frames according to a change of the traveling direction of the vehicle. After step S1040 ends, the image capture method may return to step S1010 to continue to capture image frames.

In step S1040, when the traveling direction of the vehicle is changed from a first direction to a second direction, the steps of adjusting the cropping window includes moving the cropping window on the taken image frames along a specific direction corresponding to the second direction. In addition, in step S1010 of taking the image frames, the image frames are taken according to the camera window. The camera window in the present embodiment is larger than or equal to the cropping window. Besides, the camera window may also be adjusted in step S1010 to change a range for taking image frames.

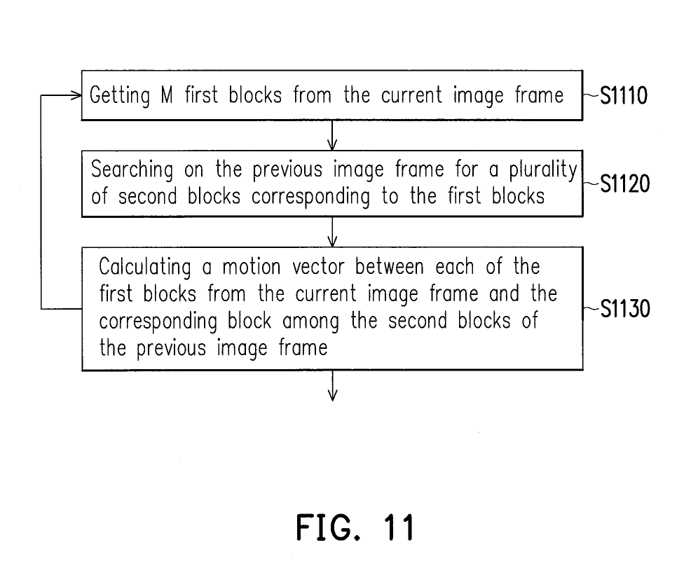

FIG. 11 is a flowchart illustrating the detailed method of determining the traveling direction of the vehicle in step S1030 of FIG. 10. In step S1030, a method of determining the traveling direction of the vehicle is to calculate a plurality of motion vectors between a current image frame and a previous image frame among the captured image frames Image′ so as to determine the traveling direction of the vehicle according to the motion vectors. The specific steps includes as follows. In step S1110, M first blocks are gotten from the current image frame. Then, in step S1120, a plurality of second blocks corresponding to the first blocks is searched on the previous image frame. In step S1130, between the current image frame and the previous image frame, a motion vector between each of the first blocks and the corresponding block among the second blocks is calculated. Therein, M is a positive integer. Besides, in the step of determining the traveling direction of the vehicle, the traveling direction of the vehicle may also be determined according to a portion of the motion vectors.

The image capture method may further include compressing the captured image frames according to an image compression standard and storing the compressed image frames. The details of the aforementioned image capture method may be sufficiently taught, suggested and described according to the embodiments illustrated in FIG. 1 throughout FIG. 9 and thus, will not be repeated.

In view of the forgoing, according to the embodiments of the invention, the image capture system determines the traveling direction of the vehicle and adjusts the range of taking or capturing the image frames according to the traveling direction. By adjusting the camera window and the cropping window, the image capture system can capture the image frames in desired viewing angles under a limited image resolution so as to accurately record image frames and save the storage space for storing the image frames.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An image capture system, adapted for a movable vehicle, the image capture system comprising:
a camera apparatus;
a positioning analyzer, determining a traveling direction of the vehicle; and
a capture apparatus, coupled to the camera apparatus and the positioning analyzer, receiving a plurality of image frames taken by the camera apparatus, capturing the plurality of image frames according to a cropping window, and deciding whether to correspondingly adjust the cropping window according to the traveling direction determined by the positioning analyzer.

2. The image capture system according to claim 1, wherein when the traveling direction of the vehicle is changed from a first direction to a second direction, the capture apparatus moves the cropping window on the image frames along a specific direction corresponding to the second direction.

3. The image capture system according to claim 1, wherein the camera apparatus has a camera window and takes the plurality of image frames according to the camera window, wherein the camera window is larger than or equal to the cropping window.

4. The image capture system according to claim 3, wherein the positioning analyzer is further coupled to the camera apparatus and outputs an adjustment instruction to the camera apparatus, and the camera apparatus adjusts the camera window according to the adjustment instruction and takes the plurality of image frames according to the camera window.

5. The image capture system according to claim 1, wherein the positioning analyzer receives the plurality of image frames captured by the capture apparatus and calculates a plurality of motion vectors between a current image frame and a previous image frame among the captured image frames so as to determine the traveling direction of the vehicle according to the plurality of motion vectors.

6. The image capture system according to claim 5, wherein when calculating the plurality of motion vectors between the current image frame and the previous image frame, M first blocks are gotten from the current image frame, multiple second blocks corresponding to the first blocks are searched on the previous image frame and the motion vector between each of first blocks and the corresponding block among the plurality of second blocks is calculated, wherein M is a positive integer.

7. The image capture system according to claim 5, wherein the positioning analyzer determines the traveling direction of the vehicle according to a portion of the plurality of motion vectors.

8. The image capture system according to claim 5, wherein the positioning analyzer comprises:
a first buffer; and
a second buffer,
wherein the first buffer and the second buffer are configured to store the current image frame and the previous image frame, respectively.

9. The image capture system according to claim 1, further comprising:
an image compression unit, coupled to the capture apparatus and compressing the plurality of image frames captured by the capture apparatus according to an image compression standard.

10. The image capture system according to claim 9, further comprising:
a memory unit, coupled to the image compression unit and storing the plurality of image frames compressed by the image compression unit.

11. The image capture system according to claim 1, wherein the positioning analyzer comprises a gyroscope, an electronic compass (e-compass) or a global position system (GPS) to determine the traveling direction of the vehicle.

12. An image capture method, adapted for an image capture system installed on a movable vehicle, the image capture method comprising:
taking a plurality of image frames;
capturing the plurality of image frames according to a cropping window;
determining a traveling direction of the vehicle; and
adjusting the cropping window according to the traveling direction of the vehicle.

13. The image capture method according to claim 12, wherein the step of adjusting the cropping window further comprises:
when the traveling direction of the vehicle is changed from a first direction to a second direction, moving the cropping window on the plurality of image frames along a specific direction corresponding to the second direction.

14. The image capture method according to claim 12, wherein the step of taking the plurality of image frames further comprises:
taking the plurality of image frames according a camera window, wherein the camera window is larger than or equal to the cropping window.

15. The image capture method according to claim 14, further comprising:
adjusting the camera window and taking the plurality of image frames according to the camera window.

16. The image capture method according to claim 12, wherein the step of determining the traveling direction of the vehicle comprises:
calculating a plurality of motion vectors between a current image frame and a previous image frame among the captured image frames so as to determine the traveling direction of the vehicle according to the plurality of motion vectors.

17. The image capture method according to claim 16, wherein the step of calculating the plurality of motion vectors further comprises:
getting M first blocks from the current image frame;
searching for a plurality of second blocks corresponding to the first blocks on the previous image frame; and
calculating the motion vector between each of first blocks from the current image frame and the corresponding block among the plurality of second blocks on the previous image frame,
wherein M is a positive integer.

18. The image capture method according to claim 16, wherein the step of determining the traveling direction further comprises:
determining the traveling direction of the vehicle according to a portion of the plurality of motion vectors.

19. The image capture method according to claim 12, further comprising:
compressing the captured image frames according to an image compression standard; and
storing the compressed image frames.

20. An image capture system, adapted for a movable vehicle, the image capture system comprising:
a camera apparatus, adjusting a camera window according to an adjustment instruction, and taking a plurality of image frames according to the camera window;
a capture apparatus, coupled to the camera apparatus and receiving the plurality of image frames taken by the camera apparatus; and
a positioning analyzer, coupled to the capture apparatus and the camera apparatus, determining a traveling direction of the vehicle and outputting the adjustment instruction to the camera apparatus according to the traveling direction.

21. The image capture system according to claim 20, wherein when the traveling direction of the vehicle is changed, the camera apparatus adjusts the camera window according to the adjustment instruction.

22. The image capture system according to claim 20, wherein the positioning analyzer calculates a plurality of motion vectors between a current image frame and a previous image frame among the plurality of image frames so as to determine the traveling direction of the vehicle according to the plurality of motion vectors.

23. The image capture system according to claim 22, wherein when calculating the plurality of motion vectors between the current image frame and the previous image frame, M first blocks are gotten from the current image frame, multiple second blocks corresponding to the first blocks are searched on the previous image frame, and the motion vector between each of first blocks and the corresponding block among the plurality of second blocks is calculated, wherein M is a positive integer.

24. The image capture system according to claim 22, wherein the positioning analyzer determines the traveling direction of the vehicle according to a portion of the plurality of motion vectors.

25. The image capture system according to claim 22, wherein the positioning analyzer comprises:
a first buffer; and
a second buffer,
wherein the first buffer and the second buffer are configured to store the current image frame and the previous image frame, respectively.

26. The image capture system according to claim 20, further comprising:
an image compression unit, coupled to the capture apparatus and compressing the plurality of image frames captured by the capture apparatus according to an image compression standard.

27. The image capture system according to claim 26, further comprising:
a memory unit, coupled to the image compression unit and storing the plurality of image frames compressed by the image compression unit.

28. The image capture system according to claim 20, wherein the positioning analyzer comprises a gyroscope, an electronic compass (e-compass) or a global position system (GPS) to determine the traveling direction of the vehicle.

29. An image capture system, adapted for a movable vehicle, the image capture system comprising:
a camera apparatus, adjusting a camera window according to an adjustment instruction and taking a plurality of image frames according to the camera window;
a positioning analyzer, determining a traveling direction of the vehicle; and
a capture apparatus, coupled to the camera apparatus and the positioning analyzer, receiving the plurality of image frames taken by the camera apparatus; and outputting the adjustment instruction to the camera apparatus according to the traveling direction.

30. The image capture system according to claim 29, wherein when the traveling direction of the vehicle is changed, the camera apparatus adjusts the camera window according to the adjustment instruction.

31. The image capture system according to claim 29, wherein the positioning analyzer calculates a plurality of motion vectors between a current image frame and a previous image frame among the plurality of image frames so as to determine the traveling direction of the vehicle according to the plurality of motion vectors.

32. The image capture system according to claim 31, wherein when calculating the plurality of motion vectors between the current image frame and the previous image frame, M first blocks are gotten from the current image frame, multiple second blocks corresponding to the first blocks are searched on the previous image frame, and the motion vector between each of first blocks and the corresponding block among the plurality of second blocks is calculated, wherein M is a positive integer.

33. The image capture system according to claim 31, wherein the positioning analyzer determines the traveling direction of the vehicle according to a portion of the plurality of motion vectors.

34. The image capture system according to claim 31, wherein the positioning analyzer comprises:
a first buffer; and
a second buffer,
wherein the first buffer and the second buffer are configured to store the current image frame and the previous image frame, respectively.

35. The image capture system according to claim 29, further comprising:
an image compression unit, coupled to the capture apparatus and compressing the plurality of image frames captured by the capture apparatus according to an image compression standard.

36. The image capture system according to claim 35, further comprising:
a memory unit, coupled to the image compression unit and storing the plurality of image frames compressed by the image compression unit.

37. The image capture system according to claim 29, wherein the positioning analyzer comprises a gyroscope, an electronic compass (e-compass) or a global position system (GPS) to determine the traveling direction of the vehicle.
